(19) United States
(12) Patent Application Publication
(10) Pub. No.: US 2003/0042298 A1
(43) Pub. Date: Mar. 6, 2003

(54) Paperless system for the display and registry of choices and the collection of data entered online and offline in elections and surveys

(76) Inventors: Rodney F. Allen JR., Tallahassee, FL (US); William Daniel Norwood, Tallahassee, FL (US)

Correspondence Address: PORTER WRIGHT MORRIS & ARTHUR, LLP, INTELLECTUAL PROPERTY GROUP, 41 SOUTH HIGH STREET, 28TH FLOOR, COLUMBUS, OH, 43215

(21) Appl. No.: 09/772,625

(22) Filed: Jan. 30, 2001

(51) Int. Cl. G06F 17/00

(52) U.S. Cl. 235/375

(57) ABSTRACT

A paperless system for the online and offline collection of data representing votes cast and choices registered in elections and surveys is administered at a master Website at which election/survey and voter/participant data and qualifications are maintained and associated in a database with parameters for a uniquely identified election or survey event. Voter/participant identity records with a password are also maintained in the database and embedded on a smart card that is issued to a voter/participant upon registration. Upon the occurrence of an election/survey event, the smart card is entered in a terminal mechanism to permit voting or choice selection. Individual votes and choices are transmitted to the master Website in real time or in batches where they are tabulated and analyzed. After voting, an indicia is placed on the smart card to prevent its reuse for subsequent participation in the same event.

### CROSS-REFERENCE TO RELATED APPLICATIONS

This application is related to our applications Ser. No. ______, “Web-Based Smart Card System and Method for Checking Card Holder Status Information to Verify Eligibility for Specific Events” and Ser. No. ______, “Vehicle Service and Maintenance Tracking Systems,” both filed concurrently herewith, and incorporated by reference herein as if set forth in full.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

This invention relates to the collection of data entered by a voter or respondent, respectively, in an election or survey, in a web-based, paperless environment that enables online and offline voting and the collection of information in elections and surveys. Votes are cast, or choices selected, using a ballot or survey questions displayed on the screen of a remote terminal that prompts participant activity after the identify and authorization of the participant is verified with responses to eligibility criteria.

In the prior art, elections have typically been administered in a paper driven environment having consequent disadvantages that may have resulted in fraud, miscounts, lost ballots, expenses in labor and ballot printing costs, and inaccuracies in vote registration and compilation. The present system eliminates the need for paper, provides a more accurate count which is tallied by a computer, reducing opportunities for human error and inconsistency. The invention has a smaller margin of error and provides improved security that allows only one vote per cardholder. The system is smart card and Web based and is less expensive than and eliminates paper mechanisms for vote registration. The invention will be useful to institutions and businesses or government offices that run elections or conduct surveys. Certain aspects of smart cards and uses therefor are described, inter alia, in U.S. Pat. Nos. 5,679,945, “Intelligent Card Reader Having Emulation Features” and U.S. Pat. No. 5,969,316, “Smart Card for Offline Automated Meal Plans,” both issued to the assignee of the present application.

### BRIEF SUMMARY OF THE INVENTION

The invention involves the creation and management of an election or survey. Initially, administrators create uniquely identified election or survey events via a proprietary and controlled Website using an HTML-based ballot creation and management administration utility. This is where the ballots will be created, choices will be entered, the dates and times of when the polls will open, as well as the criteria necessary to vote i.e., the data types that will be accepted for eligible voters are established and maintained. The data is stored in a database and the administration utility generates ballots for use with voting software that displays the ballot or survey on a laptop computer and a smart card reader (offline), a point-of-sale terminal and a PC/laptop (online), or a portable handheld device.

After election parameters have been established, the paperless election ballots will be made available for smart card holders that are eligible to vote. Voters can vote in three ways: (1) In an online environment, voters log onto the voting Website on a computer designated for voting and insert a voter identificaton smart card into the attached reader. The eligibility information on the chip is read and verified for voting eligibility. The voter is then asked to enter a valid password. After a valid password is entered, the ballot is assembled based on the voter's credentials and the ballot and choices are displayed and the cardholder is prompted to vote. (2) In an offline environment, voters will insert the smart card in a reader attached to a PC/laptop. The status information will be read and verified and the user is then asked to enter a valid password. After a valid password has been entered, the applicable ballot will display and allow the user to vote. (3) Using a portable handheld reader, a voter inserts the voter identification smart card into the reader.

Card authenticity and voter eligibility is verified using a Secure Access Module (SAM) that has been placed in each device. In addition, the cardholder will have to enter a valid pass code in order to vote. After voting, a specific field value is written into a file on the card chip, which prevents the cardholder from voting again using the same card in the same election.

After the votes are cast, encrypted and the voter's smart card is marked as having voted, votes are stored in a database and are tallied at the end of the election. The votes (both online and offline) are collected and tabulated from the database through the central control or master web site. Offline votes are transferred to a designated server at the central control or master web site to be tallied with the votes that were cast online.

The system administrator can then generate reports and publish the results. Reports indicate how many votes were cast for each candidate on individual ballots.

The software system is programmed using Visual Basic, Active Server Pages, Java and VB Script, SQL Server, Microsoft Front Page, Microsoft Notepad and C++ using smart cards.

The invention is described more fully in the following description of the preferred embodiment considered in view of the drawings in which:

### BRIEF DESCRIPTION OF THE SEVERAL VIEWS OF THE DRAWING

FIG. 1 shows mechanisms of the invention in their operative interrelationship.

FIG. 2 shows an alternative representation of the relationships of online and offline vote client terminals and the master server and databases interconnected in an intranet or the Internet.

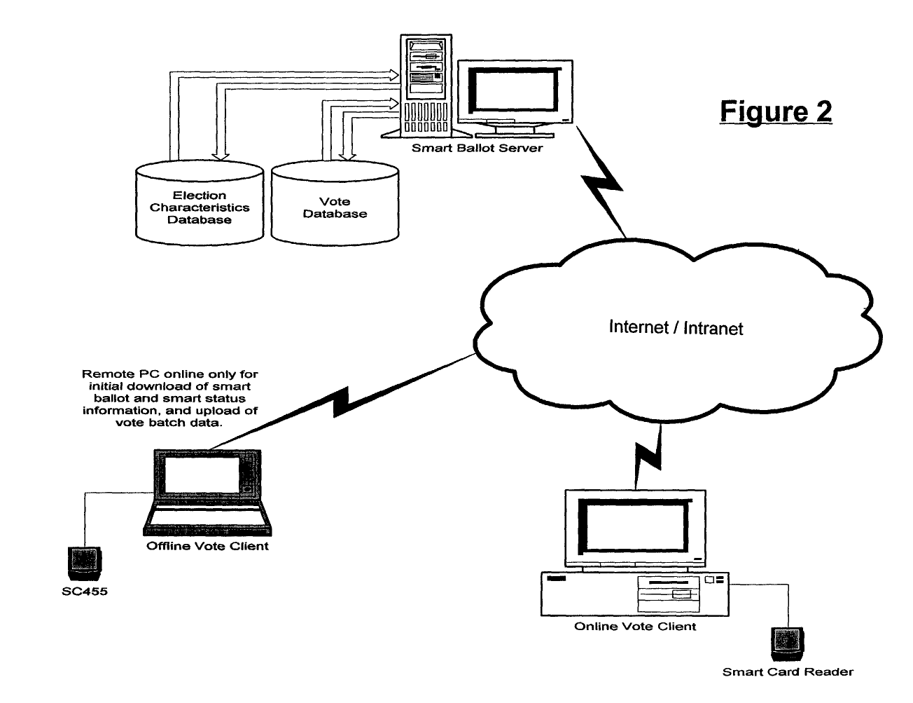

### DETAILED DESCRIPTION OF THE INVENTION

In summary, the system for the collection of data in elections and surveys includes a central processing unit interconnected with a first database in which data concerning (1) the identity of a participant, (2) the parameters of a predetermined election or survey and (3) the eligibility parameters of a participant for a predetermined election or survey is entered and maintained. A terminal remote from the central processing unit is interconnected in a network with the database, through which terminal, participant identity data can be entered into the database in a correspondence of the identity data of a participant with eligibility parameters for a predetermined election or survey. A password is assigned each participant upon registry in the database. The terminal includes known means for generating a participant smart card having stored thereon data concerning the identity of a participant and an eligibility verification of the participant to participate in a predetermined election or survey. Such data is entered into the database in a correspondence with the data stored in the smart card upon registration of the participant for eligibility in the predetermined election or survey and is included in a record associated with the participant and the participant's password associated with the card.

Further in the system, a terminal remote from the central processing unit is interconnected in a network with a second database through which terminal an eligible participant may enter choices in a predetermined election or survey, the choices are transmitted in the network to a second database interconnected with a central processing unit that allows a system administrator to run reports and manipulate participant choice data with regard to predetermined criteria for an election or survey.

Each participant is assigned a smart card having stored thereon identity and eligibility data concerning the participant. The smart card is identifiable by the remote terminal interconnected in a network with the second database and is activated by said terminal according to election or survey parameters regarding a participant's qualification or eligibility. At an election or survey event, smart card data is communicated to the central database whereupon the central processing unit verifies the smart card data and its associated password, thereby verifying the authorization of the participant to register a choice with regard to predetermined election or survey options. Choices registered by the participant are transmitted in real time, or in batch form following the end of the election or survey, for compilation, analysis or otherwise by the system administrator to determine the results of the election or survey.

A first phase of the invention is controlled by an administrator software application package comprising Web based Election Administration Software. Tools included in the election administration software define each unique election or survey event; an election identification is established with associated ballots, candidates and smart card-holder demographics. In the voting phase, voting by participants occurs, a vote tally is compiled, and vote validity is verified.

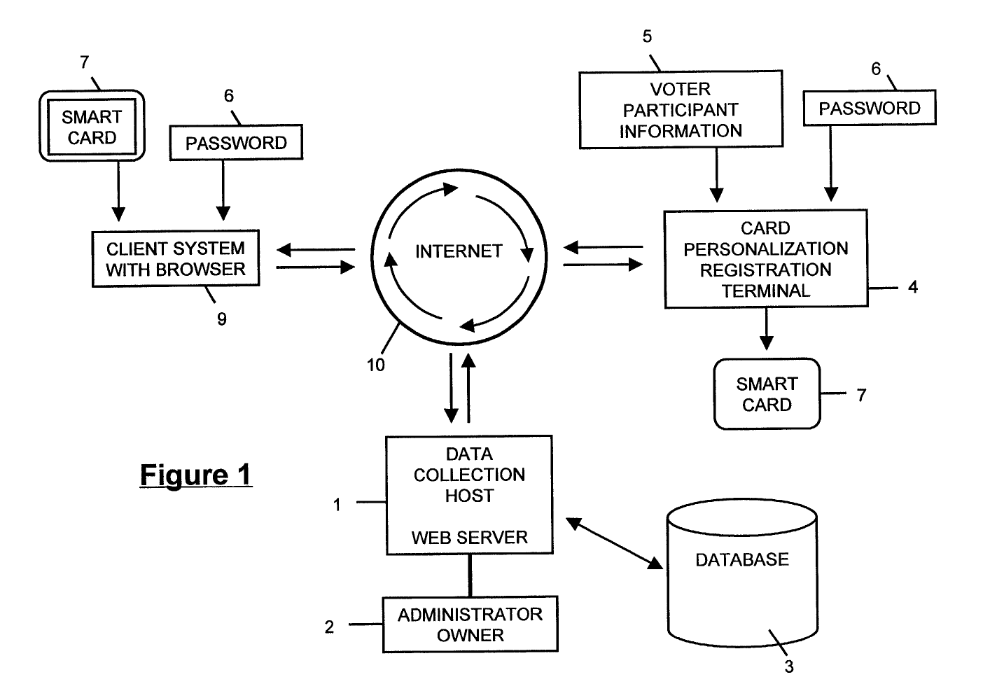

With reference to FIG. 1, for a specified election or survey event, the data collection host/web server terminal 1 is assigned a unique identity for the event and is accessible only by an authorized administrator/owner 2 that determines qualification criteria for participants and time and other parameters for the specified event, which are thereupon maintained in the database. Participant registration is conducted at remote terminal station(s) 4, at which voter participant information 5 and password information 6 with regard to individual participants is entered. The terminal generates a smart card 7 which is uniquely assigned to a participant/registrant. Election/survey criteria and qualifications as determined by the administrator/owner may also be downloaded from the host/server 1 to the registration terminal 4.

At an election or survey event, the remote client system 9 receives qualification and choice data from the host server 1, including time and other parameters for the event. A participant with a smart card 7 and password 6 enters the same at the client system terminal 6, and, receiving authorization accordingly, registers choices for tabulation. Data collection host/web server 1, card personalization registration terminal 4 and client system with browser 9 are interconnected through the Internet, indicated at 10.

Software specifications for an example of the system are set out below.

### EXAMPLE

In the following example, Web based election administration software provides tools relating to events and criteria: (1) for an election: (a) Elections, (b) Ballots, (c) Candidates and (d) Cardholder Demographics; and (2) for votes: (a) Tally Vote, (b) Verify Vote Validity, (c) Import Batch, and (d) Create Satellite Application.

The system includes a master database with characteristics for an elections table, a ballots table, the ballot owner and the number of choices available in an election. In the instance of a survey, the database is adapted to characteristics associated with survey, survey participant parameters, and survey choices.

1.0 Database

A. The Elections Table in the database stores the definition of an election, structured as follows:

1. Election ID: Each election will have unique ID number having a predetermined length and maintained in a specified order.

a. Number

b. Length: 2

2. Election Description: The description of the election will be entered in text in a file.

a. Text

b . Length: 50

3. Sponsor: The Sponsor category identifies the organization running the election and is likewise entered in text in a specified file.

a. Text

b. Length: 25

Parameters of the time and length of the election or survey are also entered into the database for each election or survey event:

| | | |
|---|---|---|
| 4. | Election Start Date: | mm/dd/yyyy |
| 5. | Election End Date: | mm/dd/yyyy |
| 6. | Election Start Time: | hh:mm (military) |
| 7. | Election End Time: | hh:mm (military) |

8. Election Key: the election key is a unique key generated upon definition using server's time and is in text having a predetermined length.

a. Text

b. Length: 14

9. The database also includes owner information in an Election Creator file in the form of the identity number of the election creator.

B. A ballots or Ballot ID table with a list of ballots is included as follows:

1. Ballot ID

2. Ballot Description

a. Text

b. Length: 50

3. Election ID: Corresponds to “Election ID” in “Elections” table.

4. A Ballot Owner file comprising the card number identifier of the ballot creator is included.

5. The number of choices available in an election or survey are maintained in a Number of Choices record in the database:

C. A Choices Table comprising a list of choices on the ballot or survey is included:

1. Choice ID

2. Choice Name

a. Text

b. Length: 50

3. A Ballot ID for each ballot corresponds to the Ballot ID record in the Ballots table.

D. A Demographics Table includes a list of codes and characteristic identifiers associated with elections and participants.

1. An Election ID record corresponds to the Election ID in the Elections table.

Codes and code type characteristic identifiers associated with election and participant identity characteristics or criteria are included:

2. Code (Example: demographics table code for characteristic identifiers.)

3. Code type (Example: indicia for the demographics table code.)

E. A Votes Table is a list of all votes.

1. Ballot ID: Corresponds to “Ballot ID” in “Ballot” table.

2. Choice ID: Choice of voter corresponding to “Choice ID” in “Choices”.

3. Write-In: Available if Choice ID=00.

4. Voter CARD NUMBER.

5. Date of vote.

6. Time of vote.

7. Location.

| | | |
|---|---|---|
| 8. | Status: | 0 = Questionable |
| | | 1 = Verified |
| | | 2 = Bad |

9. Verifier: who verified (Card Number or “SYSTEM”)

In the SYSTEM programming, unique election or survey events are created and maintained.

The Web based election administration software organizes and prompts the election/survey administrator to enter event criteria based on elections and voting.

1.1 Elections

Page ID 01: An Elections page allows the administrator to add, edit, and delete election definitions and data for entry into the database. Example screen displays and page addresses maintained at the master Website, prompting administrator input, are set out below. The page identifiers indicate the pages in a hypothetical Website <www.xxxxx.com/smartballot/>. /SmartBallot/Elections/01A.asp

Form Objects:

| | |
|---|---|
| Elections: | Dropdown. |
| Sponsor: | Text Box. |
| Election ID: | Text Box. |
| Election Name: | Text Box. |
| Election Description: | Text Box. |
| Poll Opening: | 2 Text Boxes. |
| Poll Closing: | 2 Text Boxes. |
| Delete: | Submit. |
| Save: | Submit. |
| Export Election: | Submit. |

/SmartBallot/Elections/01B.asp

Form Objects:

| | |
|---|---|
| All from 01A: | Hidden. |
| Continue: | Submit. |
| Cancel: | Submit. |

/SmartBallot/Elections/001C.asp

Form Objects:
Error

| | |
|---|---|
| Continue: | Submit. |

An “Elections” dropdown box is provided with various activity categories. Add New Election:

To add a new election, the user must select the “Add New List” selection in the “Elections” dropdown box. The user must then fill in the text boxes with the correct information and press “Save”. A new page will be displayed asking the user to confirm or cancel. Confirming will add the election to the database and return to the first page. Cancel will return the user to the first page without adding the election. Edit an Election:

To edit an election, the user must select the election to edit and simply change the content of the text boxes. To commit the change to the database, the user must press “Save”. Pressing “Save” will bring up another page asking the user to confirm or cancel this action. The user will be returned to the previous page in both cases. The user must own the election to edit. Delete:

Pressing the “Delete” button will bring up a confirmation page. If confirmed, this page will confirm and delete the selected election. If canceled, this page will return the user to the previous screen. The user must own the election to delete it.

Export:

Clicking “Export” will prepare the ballots for exportation to the offline devices.

Elections Dropdown:

Changing the dropdown will reload the page with the selected election.

1.2 Ballots

Page ID 02: A Ballots page will allow the administrator to add, edit, and remove ballots (i.e., ballot forms and pages, not completed ballots) from an election.

/SmartBallot/Ballots/02A.asp

Form Objects:

| | |
|---|---|
| Elections: | Dropdown. |
| Ballots: | Dropdown. |
| Ballot Name: | Text Box. |
| Office/Initiative: | Text Box. |
| Write-In Allowed: | Check Box. |
| Number of Choices: | List Box. |
| Save: | Submit. |
| Delete: | Submit. |
| Export: | Submit. |

/SmartBallot/Ballots/02B.asp

Form Objects:

| | |
|---|---|
| All from 02A: | Hidden. |
| Continue: | Submit. |
| Cancel: | Submit. |

Dropdown activity menus are provided.

Add Ballot:

To add a ballot, the user must first selection which election to add a ballot for. Next, the user must select “Add New Ballot” in the ballot dropdown. The user must then fill in the text boxes with the appropriate information and click “Save”. A new page will be loaded confirming or canceling the addition.

Delete Ballot:

To delete a ballot, the user simply selects the election to delete a ballot from, selects the ballot to delete, and clicks “Delete”. A new page will be loaded confirming or canceling the delete. The user must own the ballot to delete it.

Edit Ballot:

To edit a ballot the user must select the election the ballot is located in. Next, the user must select the ballot to edit. The user can then edit the ballot and click “Save”. A new page will be loaded confirming or canceling the edit. The user must own the ballot to edit it.

Export Ballot:

Clicking “Export” will append the ballot to a file on the server.

Elections Dropdown:

Changing the dropdown will reload the page with the selected election.

Ballots Dropdown:

Changing the dropdown will reload the page with the selected ballot.

1.3 Choices

Page ID 03: A Choices page will allow the administrator to add and remove choices from a ballot.

/SmartBallot/Choices/03A.asp

Form Objects:

| | |
|---|---|
| Elections: | Dropdown. |
| Ballot: | Dropdown. |
| Choice Name: | Text Box. |
| Current Choices: | List Box. |
| Add: | Submit. |
| Remove: | Submit. |

/SmartBallot/Choices/03B.asp

| | |
|---|---|
| Form Objects: | |
| All from 03A: | Hidden. |

| | |
|---|---|
| Continue: | Submit. |
| Cancel: | Submit. |

Add Choice:

After selecting the correct election and ballot, the user simply types in the candidate's name and presses the button with the arrow pointing to the right. The name will be added to the “Current Candidates” list. The user must own the ballot to add choices to it.

Remove Choice:

To remove a name from the candidate list, the user must select the name of the candidate they want to remove in the “Current Candidates” list. The user then must click the button with the arrow pointing to the left. A new page will be displayed on which the user must confirm or cancel the remove. The user will then be returned to the first page. The user must own the ballot to remove choices from it.

Elections Dropdown:

Changing the dropdown will reload the page with the selected election.

Ballot Dropdown:

Changing the dropdown will reload the page with the selected ballot.

1.4 Cardholder Demographics

Page ID 04: A Cardholder Demographics page will allow the user to choose which cardholders are eligible to vote in the election based on demographics.

/SmartBallot/CardholderDemographics/04A.asp

Form Objects:

| | |
|---|---|
| Code Type: | Dropdown. |
| Elections: | Dropdown. |
| Criteria Code: | List box. |
| Eligible: | List box. |
| Add Code: | Submit. |
| Add All Codes: | Submit. |
| Remove Code: | Submit. |
| Remove All: | Submit. |

/SmartBallot/CardholderDemographics/04B.asp

Form Objects:

| | |
|---|---|
| All from 04A: | Hidden. |

Select Code Type:

Changing the “Code Type” dropdown will make the page refresh, showing the new code type.

Select Election:

The user must first select which election to add/remove codes from. Changing this dropdown will make the page refresh showing the list of codes in the selected election.

Add Code:

The user must first select a code from the Codes identifier list box. When the user clicks the button with a single arrow pointing right, the selected code is added to the Ballots list. The user must own the ballot to add a code.

Add All Codes:

All the codes of the current code type are added to the list. The user must own the ballot to add all codes.

Remove Code:

The user must first select a code from the “Ballots” list box. When the user clicks the button with a single arrow pointing left, the selected election member is removed from the Ballots list. The user must own the ballot to remove a code.

Remove All Codes:

All the Ballots are removed from the election “members” list. The user must own the ballot to remove all codes.

1.5 Tally Votes

Page ID 05: A Tally Votes page provides is a report that will show the results for an election.

/SmartBallot/Tally/05.asp

Form Objects:

| | |
|---|---|
| Elections: | Dropdown. |

Upon change of the Elections dropdown, the page will be reloaded, printing the tally report. Ballot tabulations will be displayed, showing the aggregate results associated with each choice in number form and percent form. If write-ins exist, each write-in will be displayed for manual tabulation after the formal choices.

1.6 Verify Vote Validity

Page ID 06: A Verify Vote Validity page will check the votes marked questionable. A system check of all questionable votes will be performed to determine validity. All non-system verifiable votes will be listed and the election admininistrator must approve them.

/SmartBallot/Import/06A.asp

Form Objects:

| | |
|---|---|
| Elections: | Dropdown. |
| Ballot: | Dropdown. |
| Vote: | Dropdown. |
| Approve: | Submit. |
| Deny: | Submit. |

Show:

Choice ID.
Choice Description (or Write-in choice).
Date.
Time.
Location.

/SmartBallot/Import/06B.asp

Form Objects:

| | |
|---|---|
| All from 06A: | Hidden. |

Approve Vote:

The user/administrator must select the election and ballot to verify. Then the user must choose the vote to verify from a list of questionable votes. Upon selection of the vote, the page will refresh, showing the vote properties. The user then must click “Approve” to add make the vote non-questionable. The user must own the election to approve votes.

Deny Vote:

The user must select the election and ballot to disqualify. Then the user must choose the vote from a list of questionable votes. Upon selection of the vote, the page will refresh, showing the vote properties. The user then must click “Deny” to mark the vote “BAD”. The user must own the election to deny votes.

1.7 Import Batch

Page ID 07: Import Batch will be used on the remote collection PC's. This page will access the remote database through the DSN configuration on the satellite, create a list of votes to submit, and submit the votes to the Master Elections Administration server. Every vote cast this way will automatically be marked as questionable and verified during the transaction.

/SmartBallot/Import/07A.asp

Form Objects:

| | |
|---|---|
| Continue: | Submit |

/SmartBallot/Import/07B.asp
/SmartBallot/Import/07C.asp

07A: “Press Continue to upload Vote Batch to the SmartBallot server . . . ”

continue

07B: Creates Vote Batch, Uploads to SmartBallot server, Verifies Votes, and deletes batch from satellite.

07C: “Upload complete.”

1.8 Create Satellite Application

Page ID 08: Election Administration Software will include a tool to create the files needed on the satellite server to collect votes. These files will be created on-the-fly and downloaded from the Master Website server to the satellite upon creation.

2. Voting

Page displays and prompts are downloaded into the voting terminal mechanism.

Page ID 00: The voter will be prompted to insert his unique smart card representing eligibility and registration. Upon insert, a page will load, displaying all the elections the voter can vote for. The voter will choose one and the election will be displayed. The voter will make a selection from the available choices and press the “Vote” button, which will submit the ballot to another page on the server. This page validates votes, sorts the ballots, and submits the votes to the database. The voter will then be returned to a page showing the remaining elections (if any) the voter can vote for and the voting process is repeated. The voter can log out when done. The page will auto-log out if a time limit is reached.

Thus, it can be seen that the system involves several steps in the creation and management of an election or survey. Administrators, having verified security, identity and authority credentials, create events via a proprietary and controlled master Website using the foregoing HTML-based ballot creation and election management utility. At the Website, ballots are created with appropriate choices indicated, and the dates and times of when the polls for the specific election will open and close are administered and maintained in the Website database. Similarly, the criteria necessary to vote or participate, i.e., the data types defining criteria that will be accepted for eligible voters are maintained in a database at the Website. The utility program generates ballots for voting software that is accessible by download over the Internet from a laptop computer with a smart card reader (offline), a point-of-sale terminal and a PC/laptop with a smart card reader (online), or a portable handheld device computer with a smart card reader.

Eligible voters can participate in an online environment by logging onto the voting Website on a computer terminal or point of access device designated for voting and inserting the smart card into the associated reader. Eligibility information on the chip is read and verified for voting eligibility. The voter is then asked to enter a valid password. After a valid password is entered, the ballot is assembled based on the voter's credentials and displayed allowing the cardholder to vote. In an offline environment, voters insert the smart card in a reader attached to a PC/laptop in which status information is read and verified and the user is then asked to enter a valid password. After a valid password has been entered, the applicable ballot will display and allow the user to vote. Using a portable handheld reader, a voter inserts the voter's assigned smart card into the reader; card authenticity and voter eligibility is verified using a Secure Access Module (SAM) placed in each device. Upon entering a valid pass code, voting proceeds.

After voting, a specific field value is written into a file on the smart card chip preventing the card holder from using the same card to vote again in the same election.

3. Voting

Votes are stored in a database and are tallied at the end of the election. Both online and offline votes are collected and tabulated from the database through the central control or master web site. The offline votes are transferred to a designated server at the central control or master web site to be tallied with the votes that were cast online. Reports indicating total votes cast for each candidate (or survey choice) on the individual ballots entered are generated and the results are published.

Having described the invention in detail, those skilled in the art will appreciate that, given the present disclosure; modifications may be made to the invention without departing from the spirit of the inventive concept herein described. Rather, it is intended that the scope of the invention be determined by the appended claims.

1. A system for the collection of data in elections and surveys comprising: a central processing unit interconnected with a database in which data records concerning (1) the identity of a participant, (2) the parameters of a predetermined election or survey and (3) the eligibility parameters of a participant for a predetermined election or survey are entered and maintained;
a terminal remote from the central processing unit interconnected in a network with the database through which terminal participant identity data can be entered into the database in a record in correspondence with the identity data of a participant and eligibility parameters for a predetermined election or survey;
a mechanism for generating a participant smart card having stored thereon data concerning the identity of a participant and an eligibility verification of the participant to participate in a predetermined election or survey, said data being entered into the smart card in a correspondence with the identity and eligibility of the participant and a password associated with the smart card;
a terminal remote from the central processing unit interconnected in a network with a second database through which terminal the smart card and password of an eligible participant is verified and through which the participant may enter choices in a predetermined election or survey, said choices being transmitted in the network to a database interconnected with a central processing unit that allows a system administrator to run reports and manipulate participant choice data with regard to predetermined criteria for an election or survey;
a participant smart card having stored thereon identity and eligibility data concerning the participant, said smart card being identifiable by the remote terminal interconnected in a network with the database and activating said terminal according to election or survey parameters regarding a participant,
whereupon, upon authorization based upon data in the smart card and password entered, the remote terminal displays a form having multiple choices from which the participant may choose with regard to criteria for a predetermined election or survey.

2. The system of claim 1 in which an indicia is placed upon the smart card by the terminal in which the card is entered preventing the card from being used by the participant to authorize voting a second time in the same election or survey.

3. The system of claim 1 in which the remote terminal that verifies the smart card and password of the participant is an on-line terminal interconnected to the database by the Internet.

4. The system of claim 1 in which the remote terminal that verifies the smart card and password of the participant and displays the choices is an off-line terminal connectable to the Internet for transmission of the choice to the database.

5. The system of claim 4 in which the offline terminal has a remote database in which participant verification and choice data are stored and thereafter transmitted to the database for processing.

6. The system of claim 1 including a central server interconnected to a database including records for election characteristics and voter characteristics.

7. The system of claim 6 in which the database including records for election characteristics and voter characteristics is a single database.

8. The system of claim 6 in which the separate databases including records for election characteristics and voter characteristics are interconnected with the server.
